(19) United States
(12) Patent Application Publication
(10) Pub. No.: US 2007/0059140 A1
(43) Pub. Date: Mar. 15, 2007

(54) Drive apparatus for a mobility access device

(75) Inventor: Aaron Kiser, Royal Center, IN (US)

Correspondence Address: MICHAEL BEST & FRIEDRICH LLP, Two Prudential Plaza, 180 North Stetson Avenue, Suite 2000, CHICAGO, IL, 60601, US

(73) Assignee: THE BRAUN CORPORATION, Winamac, IN (US)

(21) Appl. No.: 10/576,646

(22) PCT Filed: Oct. 12, 2004
(86) PCT No.: PCT/US04/33643

§ 371 Date: Apr. 21, 2006

Related U.S. Application Data
(60) Provisional application No. 60/513,172, filed on Oct. 21, 2003.

(51) Int. Cl. B60P 1/00

(52) U.S. Cl. 414/545

(57) ABSTRACT

A linear drive system for reversibly operating a wheelchair ramp or other mobility access device is provided. The drive system for the mobility access device includes an actuator and a drive apparatus coupled thereto for moving the access device or portion thereof. The actuator, which may be a hydraulic cylinder, electric actuator or the like, has a linearly moving arm that cooperates with the drive apparatus including a gear rack and a spur gear. The gear rack is coupled to the moving arm and mates with the spur gear that rotates on a shaft in response to the linear movement of the moving arm. A drive link is coupled with the spur gear for pivoting about the shaft to deploy and stow the access device.

### CROSS-REFERENCE TO RELATED APPLICATION

This application claims the benefit of U.S. Provisional Patent Application No. 60/513,172, filed Oct. 21, 2003.

### FIELD OF THE INVENTION

The invention relates to mobility access devices. More particularly, the present invention relates to a drive apparatus for a mobility access device such as a vehicle wheelchair ramp.

### BACKGROUND OF THE INVENTION

Wheelchair ramp systems and other mobility access devices for vehicles and the like are well known, and have been employed to enable persons who are physically challenged or otherwise have limited mobility to board and leave a vehicle, building or the like. Various wheelchair ramp systems have been proposed that include electrical, pneumatic, or hydraulic drive systems. Additionally, various drive mechanisms have been proposed for such foregoing mobility access devices and wheelchair ramp systems that effect rotary actuation, linear actuation, or other actuation known in the art. Regardless of whether the drive mechanism is electrical, hydraulic, rotary, or linear, it is desirable to maintain a constant speed and torque while driving the ramp or other device to provide predictable movement of the ramp or device during deployment and stowage. In view of the foregoing, a need exists for an improved drive mechanism for wheelchair ramps and other mobility access devices.

### SUMMARY OF THE INVENTION

One embodiment of the invention provides a drive apparatus for reversibly moving a mobility access device such as a wheelchair ramp. The drive system for the mobility access device includes an actuator and the subject drive apparatus. The actuator, which may be a hydraulic cylinder, electric actuator or the like, has a linearly moving arm that cooperates with the drive apparatus. The drive apparatus includes a gear rack and a spur gear. The gear rack is coupled to the moving arm and mates with the spur gear that rotates on a shaft in response to the linear movement of the moving arm of the actuator. A drive link is coupled with the spur gear for pivoting about the shaft to deploy and stow the access device.

### BRIEF DESCRIPTION OF THE DRAWINGS

The present invention is described with reference to the accompanying figures which illustrate embodiments of the present invention. However, it should be noted that the invention as disclosed in the accompanying figures and appendices is illustrated by way of example only.

FIG. 1 illustrates a perspective view of an exemplary wheelchair ramp for which the subject drive apparatus may be employed;

FIG. 2 illustrates a view of the exemplary wheelchair ramp of FIG. 1 with the cover removed to show the internal components including an exemplary drive system;

FIG. 3 is a partial view of the exemplary wheelchair ramp of FIG. 2 illustrating an exemplary drive apparatus;

FIG. 4 is a side view of the exemplary drive apparatus of FIG. 3; and

FIG. 4A is a detail view of FIG. 4, illustrating a drive apparatus support member.

### DETAILED DESCRIPTION OF THE EXEMPLARY EMBODIMENTS

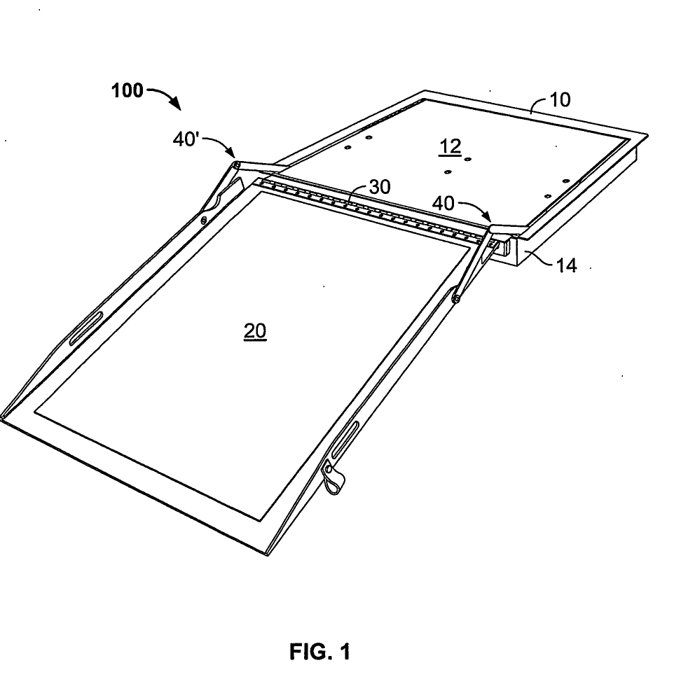

Referring now to the figures, a drive apparatus for a vehicle mobility access device is described. As shown in FIG. 1, one exemplary vehicle mobility access device for which the subject drive apparatus may be employed is illustrated as a flip-over type wheelchair ramp. Although the ramp is illustrated as a flip-over type ramp, the ramp may be other types of ramps such as a bi-fold or multi-fold ramp, a telescoping ramp or other ramps known in the art. Additionally, the subject drive apparatus is not limited for use with ramps and may also be used with other types of mobility access devices, such as wheelchair lifts including under-vehicle lifts, stepwell lifts, parallel arm lifts as well as other lifts known in the art. Indeed, the subject drive apparatus may also be used to reversibly drive other types of devices and is not limited to mobility access devices.

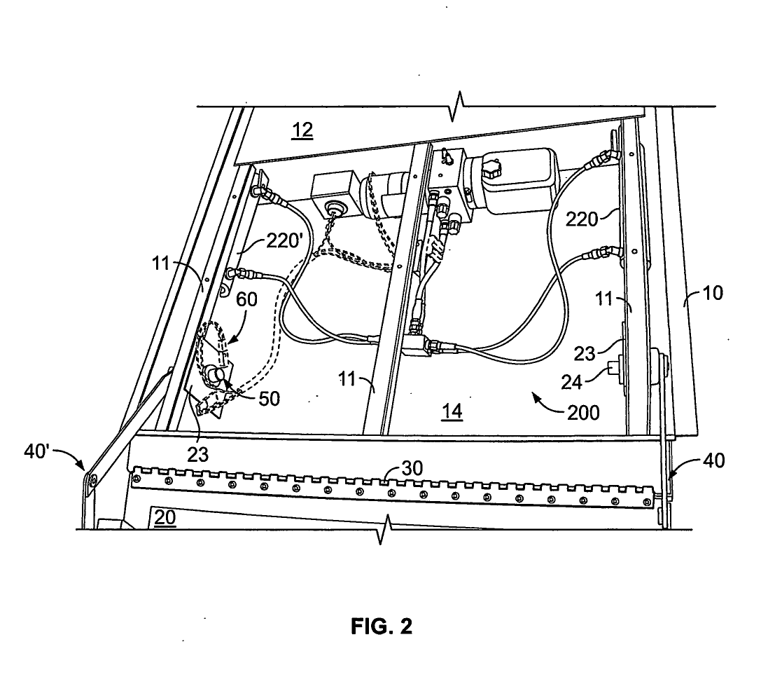

As shown, the mobility access device hereinafter referred to as ramp system 100 includes a mounting enclosure 10 that is typically coupled with the floor of a vehicle threshold so that persons who are physically challenged or otherwise have limited mobility may board and leave a vehicle, such as a minivan, bus, or the like through a proximate sliding or swinging door. The mounting enclosure 10, which is generally rectangular in shape, includes a cover plate 12 and a pan 14 that is recessed into the vehicle floor. As best illustrated in FIG. 2, at least a portion of the cover plate 12 may be removably attached to the pan 14 so that the ramp's drive system components, which are discussed hereafter in further detail, such as mechanical, electrical and hydraulic parts housed within the enclosure 10 may be maintained, repaired, or replaced. Further as shown, support member 11 traverses the pan 14 from the inboard side to the outboard side for supporting and attaching the removable portion of the cover plate 12. There are three support members 11 as shown, but fewer or additional support members 11 may be provided. The support member 11 will be described in further detail hereinafter. As can be appreciated from FIGS. 1 and 2, the ramp drive system components are fully enclosed within the enclosure 10 so that the wheelchair ramp is substantially self contained and may be installed in suitable vehicles as a “drop-in” system with minimal vehicle modifications such as floor lowering or roof conversion. Additionally, for those embodiments including a hydraulic drive system with a hydraulic actuator, potential hydraulic fluid leaks will be contained within the pan 14, hydraulic line routing is minimized and only electrical connections from the vehicle to the ramp system 100 may be required.

For ease of reference, the modifier “inboard” shall refer to a direction toward the vehicle in which the ramp is installed, whereas the modifier “outboard” shall refer to a direction away or outward from the vehicle. As best illustrated in FIG. 1, the ramp system 100 includes a movable ramp section 20 that is coupled to the outboard edge of the enclosure 10 by a hinge 30, which may be a piano hinge or the like. The hinge 30 allows the ramp section 20 to move between a stowed orientation in which it is folded substantially flat against the cover plate 12, and a deployed orientation that is achieved by pivoting the ramp section 20 from its stowed orientation through an angle of more than 180 degrees with respect to the plane defining the vehicle threshold surface. As shown, the ramp section 20 may include upwardly projecting side barriers for preventing a ramp user from falling off the right or left sides of the ramp section 20. Further, one or both of the side barriers may include a hand hole, strap or the like that can be gripped by the ramp user or operator to facilitate manual stowage and deployment of the ramp section 20 such as during a malfunction or loss of electrical power to the ramp system 100. As previously mentioned, ramp system 100 is illustrated as a flip-over ramp including one movable ramp section 20, but the ramp system 100 may be other types of ramps or devices known in the art.

As shown in FIG. 1, the ramp system 100 includes linkages 40, 40′ that couple the ramp section 20 to the ramp drive system within the enclosure 10 for moving the ramp section 20 between its stowed and deployed orientations. As can be appreciated from FIG. 2, one exemplary ramp drive system is a hydraulic system 200. Although the drive system is illustrated as a hydraulic system, the drive system may alternatively be electrical, pneumatic or include another motive force known in the art. As can be appreciated from FIG. 2, the system 200 includes one or more linear actuators comprising single-acting hydraulic cylinders 220, 220′, which are in fluid communication with a hydraulic power unit or the like. Although the hydraulic drive system 200 is illustrated as generally symmetrical with respect to a centerline through the ramp's forward and rearward (i.e., right and left) sides and includes two cylinders 220, 200′ that cooperate to move the ramp section 20 at its right and left sides, the ramp system 100 need only include one linear actuator to move the ramp section 20.

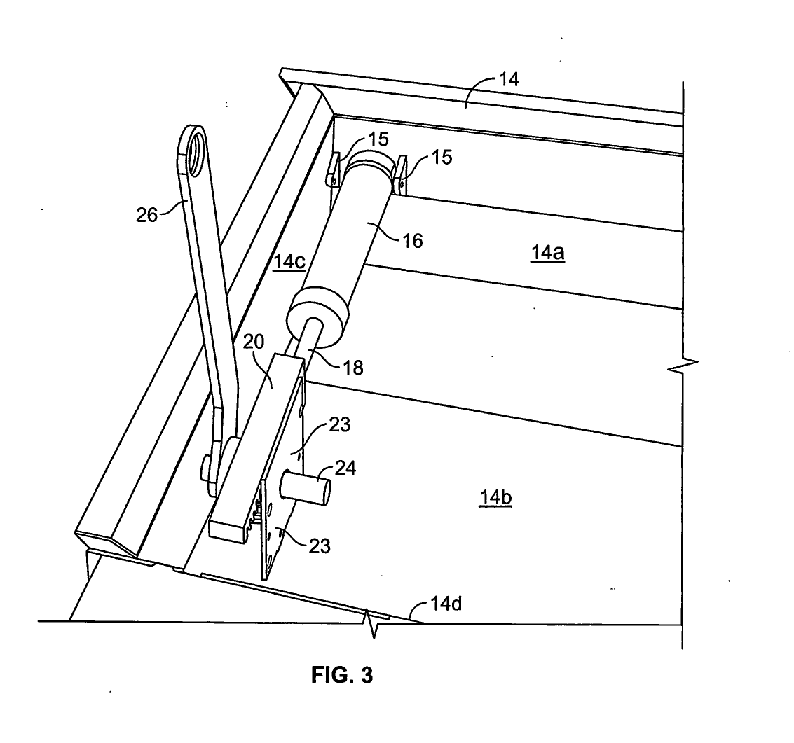

Referring now to FIG. 3, the generally vertical inboard wall 14a of the pan 14 includes a fixed attachment point 15 that is sized and shaped to retain one end of the linear actuator 16. As shown, the fixed attachment point 15 includes a spaced apart arrangement of two triangular-shaped members with holes for accepting a fastener, but other suitable shapes and arrangements of fastening members may be substituted as appropriate to cooperate with the actuator 16. Attachment point 15 may be integrally formed with the pan 14, welded or otherwise mechanically affixed thereon as known in the art. One end of the actuator 16 is fixedly retained by attachment point 15 by inserting one or more fasteners such as a bolt, screw, pin, rod or the like through the holes of attachment point 15 and a corresponding mounting hole of the actuator 16. Thus retained, the actuator 16 has a fixed end that may pivot about the attachment point 15 and a free end that may move inboardly and outboardly relative to the fixed end. As shown, the actuator 16 includes an arm or rod 18 that moves linearly into and out from a generally cylindrical housing to respectively deploy and stow the ramp in response to a ramp control, such as a hand control, switch, button or the like. As illustrated, the housing of the actuator 16 remains generally stationary as retained by attachment point 15 while the rod 18 moves between a fully withdrawn position and a fully extended position during ramp operation. The foregoing arrangement is not limiting and may alternatively be reversed such that the rod 18 is attached to the attachment point 15 for moving the body of the actuator 16 inboardly and outboardly. In exemplary embodiments where the actuator 16 comprises a hydraulic cylinder 220, the fixed end is preferred to be the piston end of the cylinder 220 so that the free end is the rod end of the cylinder 220.

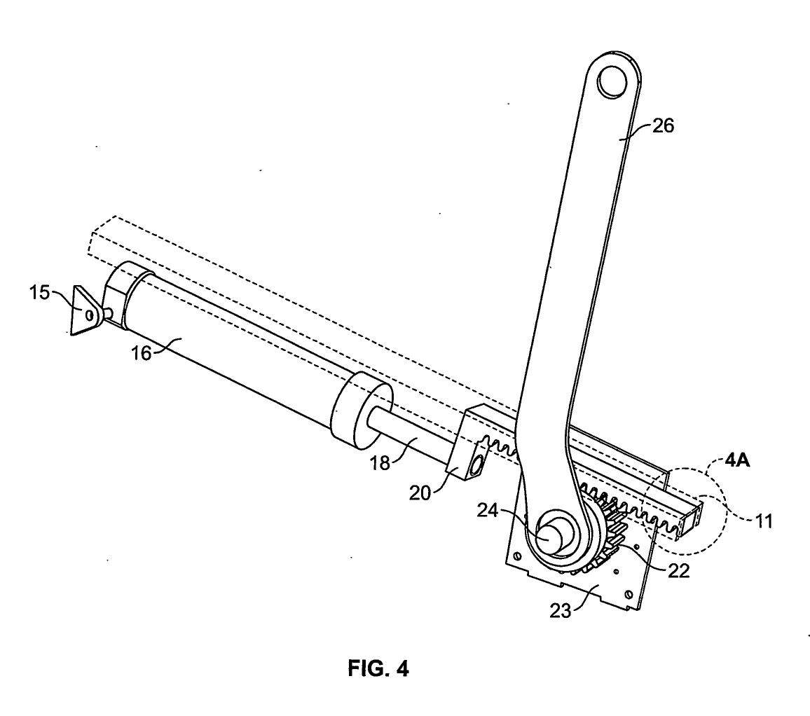

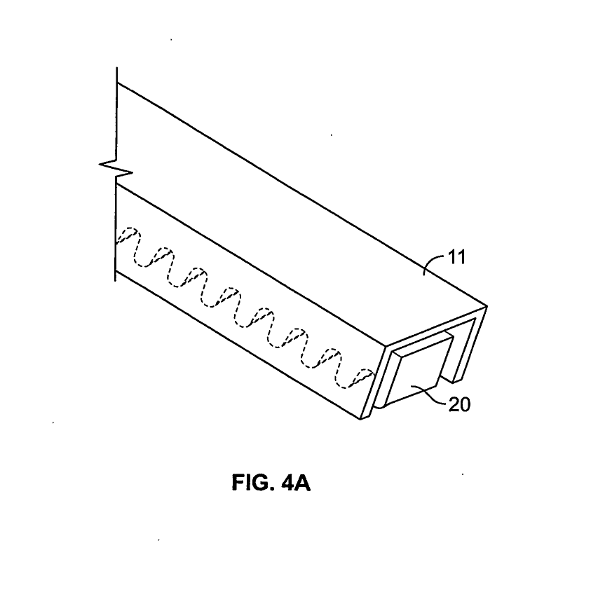

As can be appreciated from FIG. 3, a gear rack 20 is attached to the outboard end of the rod 18. As best illustrated in FIG. 4, the gear rack 20 is a generally L-shaped member, which is toothed along the bottom of its elongated side. One exemplary gear rack of this type is McMaster Carr part number 6295K152 (pitch 10; ⅝ thick; 4 feet long), but other gear racks may be suitably substituted as desired. As further shown in FIG. 4, the gear rack 20 mates with or otherwise cooperates with a spur gear 22 that is mounted to a shaft 24. One exemplary spur gear that corresponds and,cooperates with the aforementioned exemplary gear rack is McMaster Carr part number 6325K38 (pitch 10; teeth 24; pitch dia 2.400″), but other spur gears may be suitably substituted as desired so long as the teeth of the gear rack mate with the teeth of the spur gear to rotate the spur gear as the gear rack moves linearly back and forth. Other exemplary spur gears and corresponding gear racks are available from Martin Sprocket & Gear, Inc. of Arlington, Tex. Additionally, although the gear rack 20 is illustrated to be generally L-shaped, the gear rack 20 may be shaped otherwise so long as the teeth thereof may suitably mate with the spur gear.

The shaft 24 on which the spur gear 22 is mounted may be either fixed (i.e., non-rotating) or free (i.e., rotating) relative to the spur gear 22. That is, the gear 22 may either be coupled with the shaft 24 for effecting rotation of the shaft 24 or the gear 22 may be disposed on the shaft 24, which does not rotate in concert with the gear 22. As shown in FIGS. 3 and 4, a support plate 23, which may be rigidly affixed to the bottom 14b of pan 14, includes a central hole that accepts and retains a first end of the shaft 24. Similarly, a hole in the proximate side wall 14c (i.e., the left side) of pan 14 accepts and retains a second, opposing end of shaft 24, thereby holding the shaft 24 substantially horizontal and perpendicular to the actuator 16 and rod 18.

As best illustrated in FIG. 4, the driving link 26 may be bent at a slight angle proximate to its pivot end, which is coupled with one or more of the shaft 24 and spur gear 22. As such, when the actuator 16 extends the arm 18, the gear rack 20 advances linearly in the outboard direction. With reference to FIG. 4, linear advancement of the gear rack 20 directly translates to clockwise rotation of the spur gear 22 and pivoting of the driving link 26 about the shaft 24. Referring back to FIGS. 1 and 2, one can appreciate that the driving link 26 (FIGS. 3 and 4) may be a first link in a multi-link arrangement 40, 40′. Alternatively, the driving link 26 may be shaped otherwise with multiple bends or angles, or in a curvilinear shape or the like so that the distal end (i.e., the end opposite the shaft 22) of the driving link 26 may be directly coupled to the ramp section 20 for movement thereof.

Since it would be undesirable for the gear rack 20 to disengage from the spur gear 22, the support member 11 (FIG. 2 and illustrated in FIG. 4 with broken lines), which supports a portion of the cover plate 12, operates to serve as a retainer and guide for the gear rack 20. As shown in FIG. 2, the support members 11 traverse the length of the pan 14 from the inboard wall 14a to the outboard wall 14d and are positioned above the actuators 220, 220′ to prevent the rod 18 and gear rack 20 from pivoting upward. Further, the support members 11 may be fixedly attached to the support plates 23 to prevent the gear rack 20 from moving transversely and disengaging from the spur gear 22. As best illustrated in FIG. 4 and FIG. 4A, support member 11 may be inverse U-shaped or otherwise channel-shaped member to accept the gear rack 20 therein for preventing undesired movement (e.g., side to side or up and down) of the gear rack 20. In this way, the support member 11 prevents the ramp section 20 from becoming disengaged from the linear actuator 16. In addition, the support member 11 may include in its channel one or more bearings or the like to facilitate sliding of the gear rack 20 within the support member 11. The support member 11 may include a bearing such as VHMW plastic bearings that have a low coefficient of friction, good impact and abrasion resistance, and inherent lubricity, but another suitable bearing or slide-facilitating member may be used. By fully extending the rod 18 outboardly, the driving link 26 arcuately pivots about the shaft 24 through an angle of approximately 180 degrees.

As can be appreciated from FIGS. 1-4, the distal end of driving link 26 may be pivotably attached to a first end of a second (i.e., following) link, the link arrangements 40, 40′ comprising the driving link 26 and a second or driven link. The second link is pivotably coupled to the sidewall of the ramp section 20 proximate the inboard edge of the section 20. Thus arranged and pivotably connected to each other, the links of the multi-link arrangement 40, 40′ cooperate to deploy and stow the ramp in response to movement of the actuator rod 18. Although the driving link 26 is generally linear in the illustrated embodiment the driving link 26 may be alternatively shaped to facilitate a direct connection of the distal end of the link to the ramp section 20. For example and as previously mentioned, the driving link 26 may include multiple bends or angles, or have a U-shape, arcuate shape, curvilinear shape or the like so that the link 26 can stow completely within the enclosure 10 and move the ramp section 20 relative to the movement of the linear actuator 16.

In embodiments of the ramp system 100 including a hydraulic drive system 200 with a hydraulic cylinder 200, it would be advantageous to sense the position of the ramp section 20 so that after it was driven to a substantially vertical position, it may continue to deploy or stow by “floating” down under gravity power. This floating operation, known as gravity-down in the art, allows for reduced consumption of vehicle electric power and also reduced wear and tear on a hydraulic power unit 210 (FIG. 2) thereby extending the operating life of the ramp system 100. To provide for gravity-down operation of the ramp, the ramp 100 may include a sensing means having one or more switches, sensors or the like for detecting the orientation of the ramp section 20. As illustrated in FIG. 2, a cam arrangement 50 may be located on an end of the shaft 24 that moves the drive link 26. As further shown in FIG. 2, an arrangement of sensors or switches 60 (illustrated in broken lines) such as contact microswitches or the like in cooperation with the cam arrangement 50 may be disposed proximate the cam arrangement 50 and oriented for actuation by the one or more cams of the cam arrangement 50 in response to movement of the link 26. For example, a first switch or sensor of the switch arrangement 60 may be operable by a first cam to turn off the power unit 210 when the ramp section 20 is generally vertical during deployment (i.e., the ramp section 20 is moving generally outboardly), whereas a second switch or sensor of the switch arrangement 60 may be operable by a second cam to turn off the power unit 210 when the ramp section 20 is generally vertical during stowage (i.e., the ramp section 20 is moving generally inboardly), or vice versa Such first and second cams may operate to actuate the first and second switches, or second and first switches, respectively. Alternatively, since the linear travel of the rod 18 may be translated into a rotational angle indicative of the orientation of the ramp section 20, the system 100 may include a sensor that detects the linear distance that the rod 18 has traveled.

The ramp section 20 position sensors (e.g., the switches of the switch arrangement 60) may be “hard wired” to the power unit 210 or alternatively to a controller, which may be a programmable logic controller, microprocessor controller, or the like. Thus, the power unit 210 may be shut off when respective sensors are actuated during deployment and stowage so the ramp section 20 may gravity-down relative to one or more hydraulic fluid throttling means such as flow restrictors. In this way, the ramp 100 selectively operates the power unit 210 relative to the orientation of the ramp section 20 so that the ramp section 20 may be deployed and/or stowed by the force of gravity through an approximate angle of ninety degrees (i.e., from a generally vertical orientation to either the fully stowed or deployed orientation).

While a hydraulic drive system is discussed in various exemplary embodiments, an electric drive system may be substituted as an alternative. For example, the hydraulic cylinder 220 may be replaced with an electric actuator such as an electric linear actuator or the like known in the art. One exemplary family of electric linear actuators that may be used with the subject drive apparatus is the Electrak series available from Warner Electric of South Beloit, Ill., but other similar actuators may be used as well. In embodiments employing an electric actuator it would be desirable for the actuator to enable the ramp to gravity down when the actuator is deenergized. To this end, a load-holding brake functionality of the electric linear actuator (if included) may need to be disabled.

Exemplary embodiments of this invention are described herein. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A drive apparatus for a ramp, the apparatus comprising:
a linear actuator including a fixed end and a free end;
a gear rack coupled with the free end;
a complimentary gear configured to cooperate with the gear rack; and
a pivotal linkage coupled with the gear and the ramp, and configured to affect deployment and stowage of the ramp.

2. The apparatus of claim 1 wherein the linear actuator comprises a hydraulic cylinder including a body and a rod.

3. The apparatus of claim 2 wherein the fixed end comprises the body and the free end comprises the rod.

4. The apparatus of claim 2 wherein the fixed end comprises the rod and the free end comprises the body.

5. The apparatus of claim 1 wherein the linear actuator comprises an electrical actuator.

6. The apparatus of claim 1 wherein the gear rack comprises an elongate portion having a plurality of teeth configured to mate with the complimentary gear.

7. The apparatus of claim 6 wherein the elongate portion is generally parallel with the actuator.

8. The apparatus of claim 7 wherein the teeth are disposed on a bottom side of the elongate side.

9. (canceled)

10. The apparatus of claim 1 further comprising a shaft, wherein the gear and the linkage are coupled with the shaft so that the linkage is configured to pivot about the shaft in response to linear movement by the actuator.

11. The apparatus of claim 10 wherein the shaft is fixed so that the gear and linkage are configured to rotate about the shaft.

12. The apparatus of claim 10 wherein the shaft is configured to rotate with the gear and linkage.

13. The apparatus of claim 1 wherein the linkage comprises a rigid link.

14. The apparatus of claim 13 wherein the rigid link comprises a curvilinear shape.

15. The apparatus of claim 1 wherein the linkage comprises two or more rigid links coupled together.

16. A ramp system comprising:
a linear actuator;
an enclosure recessed into a floor and housing the actuator;
a ramp pivotally coupled with the enclosure; and
a linkage coupling the actuator with the ramp section, and configured to convert a linear force from the actuator to a rotational force configured to stow and deploy the ramp.

17. The system of claim 16 wherein the linear actuator comprises a cylinder in fluid communication with a power unit.

18. The system of claim 16 wherein the linear actuator comprises an electrical actuator.

19. The system of claim 16 wherein the linkage comprises two rigid links.

20. A drive apparatus for an access device having a ramp, the apparatus comprising:
a linear actuator including a fixed end and a free end;
a gear rack coupled with the free end;
a complimentary gear configured to cooperate with the gear rack; and
a linkage coupled with the gear and the ramp, and configured to affect reversible movement of the ramp.

21-34. (canceled)
